(19) United States
(12) Patent Application Publication
(10) Pub. No.: US 2026/0001202 A1
(43) Pub. Date: Jan. 1, 2026

(54) Tool for Releasing a Stuck Part

(71) Applicant: Mueller Werkzeug & Co Kg GmbH, Lichtenfels (DE)

(72) Inventor: Michael Müller, Lichtenfels (DE)

(73) Assignee: Mueller Werkzeug & Co Kg GmbH, Lichtenfels (DE)

(21) Appl. No.: 19/186,985

(22) Filed: Apr. 23, 2025

(30) Foreign Application Priority Data
Jun. 27, 2024 (DE) 202024103474

(51) Int. Cl. B25B 27/00; B25D 1/16

(52) U.S. Cl. CPC B25B 27/0035; B25D 1/16

(57) ABSTRACT

A portable tool is provided for releasing a stuck component, such as a drive shaft, diesel injector, or ball joint, using a single manually operable device. The tool comprises an impact rod with a movable impact weight and a stop at one end, and a fastening element at the other end for connecting to an adjustable cable loop. The cable loop secures around the stuck component using a tool-free adjustment mechanism that includes a bent part, a U-shaped bolt with a threaded leg, and a locking screw. A pivotable hook with a spring clip fastener connects the cable loop to the impact rod, allowing axial force transfer when the impact weight is actuated. The tool enables effective and damage-free component release by a single user without requiring additional tools, and is adaptable for use on various components in motor vehicles or other mechanical systems.

The invention relates to a portable tool with which a drive shaft of a motor vehicle or a similar stuck component, in particular with an elongated basic shape, can be released.

From DE 203 08 742 U1 a sliding hammer puller is known with which dents in the body can be repaired. For this purpose, a pulling head, which is attached to the end of a pulling rod, is fixed to the body panel using adhesive.

By triggering the sliding hammer, the body panel is pulled outwards by means of the pulling head which has a concave end surface. After a dent has been thereby pulled outward so far that the sheet metal has returned to its normal position, the adhesive can be cut through with a cutting tool, and the sliding hammer puller can be removed.

DE 34 22 798 A1 discloses a tool for releasing stuck disc brake pads by hooking steel pins into the pull holes of the brake pads and applying the necessary force thereto by releasing an impact weight on a pull rod.

GB 2531779 C describes a sliding hammer that is designed to release a wishbone. In so doing, a rod with an impact weight connects an upper plate, to which the wishbone is attached with the help of a strap, and a lower plate on which a foot stirrup is located.

The invention is based on the object of performing the removal of a stuck part, in particular a drive shaft of a motor vehicle, with only a single, easy-to-use tool compared to the prior art, without damaging any other parts in the process.

This object is achieved according to the invention by a tool having the features of claim 1.

The tool for releasing a stuck part, in particular a drive shaft of a motor vehicle, comprises an impact rod on which a movable impact weight is guided. The impact weight can in particular be designed in the shape of a dumbbell so that the user can move the impact weight with a secure manual grip towards a stop at the end of the impact rod. At the other end of the impact rod, a fastening element is attached on which a cable loop is suspended. The cable loop serves to be affixed on the drive shaft or other part to be removed. An adjustment element is provided for tool-free adjustment of the width of the cable loop to the part to be released.

According to one possible embodiment, the adjustment element comprises a folded bent part, a U-bolt as well as a locking screw. The U-shaped bolt can be divided into three sections, namely a long U-leg provided with a thread, a short U-leg, and a U-base connecting the U-legs. The three sections are each at a 90° angle to each other, although roundings between the sections are possible. The folded bent part has two opposite bent surfaces of unequal size, each of which has a hole through which the long U-leg is inserted. The U-base adjoining the long U-leg is arranged parallel to the larger of the two opposite surfaces of the bent part and ends in the short U-leg which is guided in a hole in the larger bent surface of the bent part, which is parallel to the U-base, while maintaining a distance from the smaller bent surface. The manually operated locking screw is screwed onto the thread of the long U-leg on the outer side of the shorter bent surface.

The bent part of the adjustment element optionally has a third bent surface which is aligned orthogonally to the two opposite bent surfaces on the side of the short U-leg. The third bent surface increases the stability of the bent part and protects the U-shaped bolt.

The cable loop of the tool lies between the U-base of the U-bolt and the larger bent surface of the bent part. When the locking screw is tightened, the cable loop is fixed and can no longer change its width.

The fastening element serves to connect the cable loop to the impact rod. For this purpose, the fastening element can be designed, for example, as a hook with a spring clip fastener. This is attached to a slotted adapter, which connects the hook to the impact rod, in a rotatable or pivotable manner, so that an exact axial force transmission is possible during the execution of the impact with the impact weight. In order to connect the cable loop to the hook, the ends of the cable loop are designed as eyelets which can be forced into the desired shape and reinforced by metallic elements. The material of the cable loop can be, for example, steel or carbon fiber. The cross section of the cable is not necessarily circular. For example, the cable can have a flat cross section, i.e., be designed like a belt. A protective sheath for the cable is made, for example, of textile material or plastics material.

The overall tool can be operated by a single user without the use of additional tools and can be used universally, for example on drive shafts, diesel injectors or ball joints. A drive shaft to be released can be located on the front axle or on the rear axle of a vehicle.

An exemplary embodiment of the invention is explained in more detail below with reference to a drawing in which:

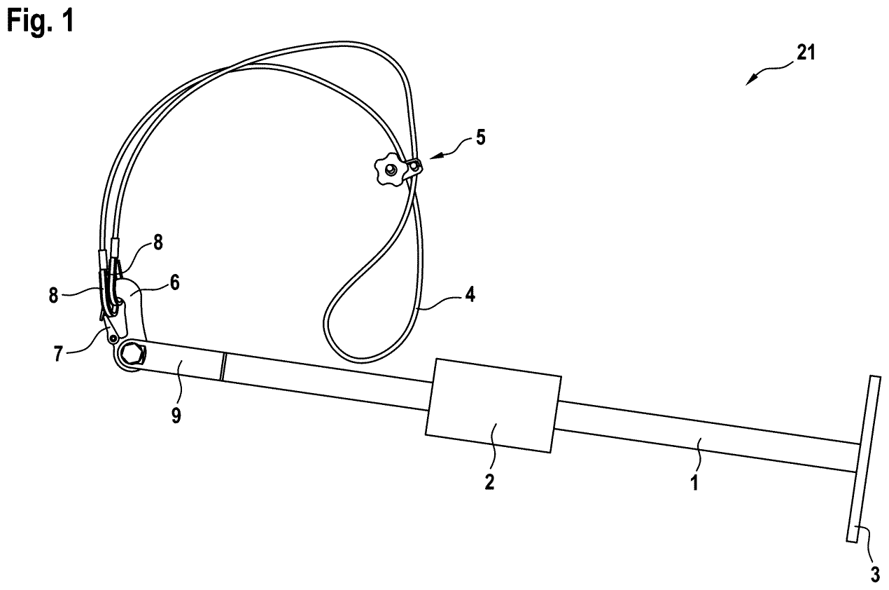

FIG. 1 shows a tool for releasing a stuck part, in particular a drive shaft,

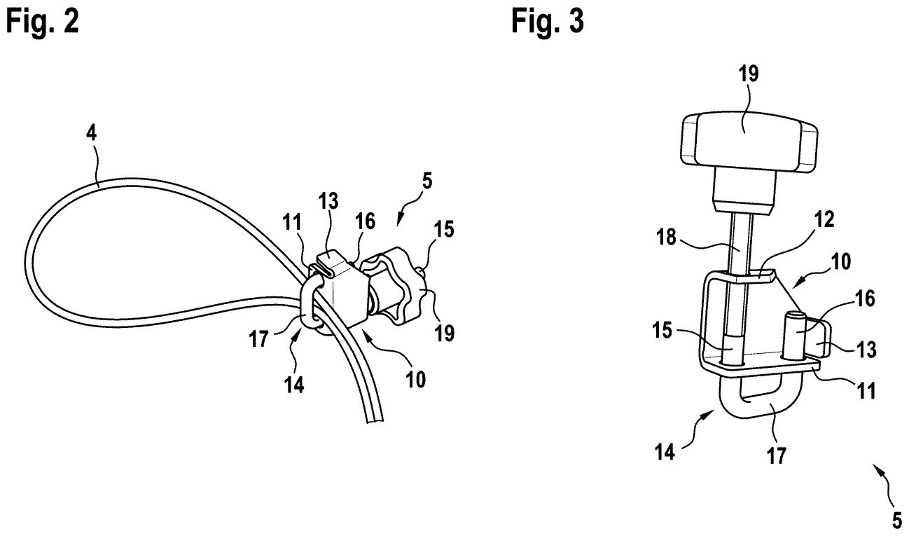

FIG. 2 shows an adjustment element of the tool according to FIG. 1 as well as a portion of a cable loop,

FIG. 3 shows a detailed representation of the adjustment element,

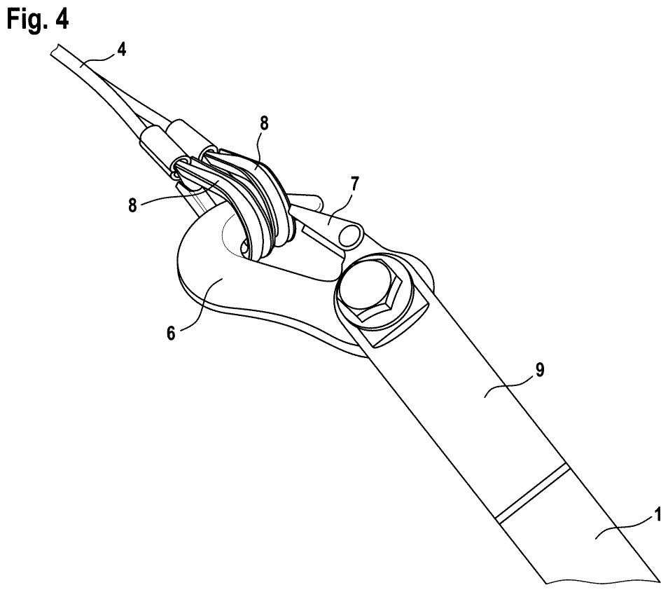

FIG. 4 shows a detailed representation of a fastening element of the tool according to FIG. 1 provided for connecting an impact rod to the cable loop,

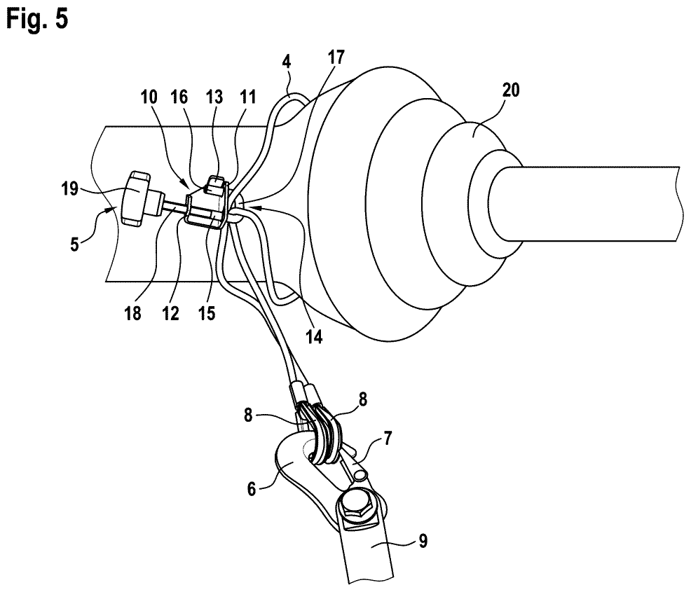

FIG. 5 shows the tool according to FIG. 1 attached to a drive shaft.

A tool, identified overall with the reference sign 21, for releasing a stuck part, in the present case a drive shaft 20 of a motor vehicle, comprises an impact rod 1, an impact weight 2 guided thereon, and a stop 3. The length of the impact rod 1 in the exemplary embodiment is approximately 0.5 m. The impact weight 2 shown in simplified form in FIG. 1 can be designed in the shape of a dumbbell to be guided with a firm grip by the user and has, for example, a weight between 2.0 and 4.0 kg. When executing the impact, the impact weight 2 is moved more or less quickly on the impact rod 1 in the direction of the stop 3, depending on the desired effect.

A fastening element 6 is attached via an adapter 9 to the end of the impact rod 1 opposite the stop 3. In the exemplary embodiment, the fastening element 6 is designed as a hook 6. This has a spring clip fastener 7 as a locking mechanism. The hook 6 is screwed to the slotted adapter 9 in a rotatable or pivotable manner in order to allow precise axial force transmission when the impact weight 2 is triggered and thereby maximize the efficiency of the tool 21.

A cable loop 4 is attached to the hook 6 by means of two eyelets 8 which are located at the two ends of the cable loop 4. The cable loop 4 serves to fix the tool 21 to the part to be released and has, for example, a length of approx. 2 m. To adjust the width of the cable loop 4, an adjustment element 5 is attached to the cable loop 4. This allows the tool 21 to be universally adapted to the part to be released, such as the drive shaft 20, a diesel injector or a ball joint, even in areas of application outside of automotive technology.

The adjustment element 5 shown in more detail in FIG. 2 and FIG. 3 comprises a bent part 10 made of sheet steel, a U-shaped bolt 14 and a locking screw 19. The bent part 10 possesses two parallel, opposite, unequal-sized bent surfaces 11, 12 which are referred to as the larger bent surface 11 and smaller bent surface 12. The U-shaped bolt 14 can be divided into a long U-leg 15 provided with a thread 18, a short U-leg 16, and a U-base 17.

The long U-leg 15 runs through the opposite bent surfaces 11, 12, each of which has a hole. The U-base 17, which connects the long U-leg 15 and the short U-leg 16, lies parallel to the larger bent surface 11 and passes through a second hole in the larger surface 11 into the small U-leg 16 which maintains a distance from the smaller bent surface 12. Adjacent to the smaller bent surface 12, the bent part 10 is beveled and possesses a third bent surface 13 at the other end of the bevel, which serves to stabilize the bent part 10 and protects the U-shaped bolt 14. The third bent surface 13 is aligned orthogonally both to the two surfaces 11, 12 as well as to a flat portion of the bent part 10 connecting the surfaces 11, 12.

The cable loop 4 is located between the U-base 17 and the larger bent surface 11. When the locking screw 19, which is screwed onto the thread 18 of the long U-leg 15, is tightened to the maximum, the cable loop 4 is accordingly fixed between the U-base 17 and the larger bent surface 11, whereby the adjustment of the width of the cable loop 4 is no longer possible.

FIG. 4 shows a detailed view of the fastening element 6 which is designed here as a hook 6 with a spring clip fastener 7. The spring clip fastener 7 makes it possible to replace the cable loop 4 in order to use a cable loop 4 made of a different material or with a different length if necessary. Materials for the cable loop 4 can be, for example, steel or carbon fibers, optionally with a sheath made of plastics material or a textile material. At the forked end of the adapter 9, the hook 6 is held by means of a screw in such a way that the swivel mobility of the hook 6 is maintained. Other mechanisms are also conceivable with which the eyelets 8 are coupled to the impact rod 1 while maintaining at least a degree of freedom. In the present case, the adapter 9 is screwed to the impact rod 1.

The use of the tool 21 on a drive shaft 20 of a motor vehicle is illustrated in FIG. 5. The cable loop 4 wraps around the part to be released, in the exemplary embodiment on the front axle of a car, while the adjusting element 5 affixes the width of the cable loop 4 so that it can no longer slip. The user holds the impact rod 1 with one hand while the cable loop 4 is taut, while striking the impact weight 2 in the direction of the stop 3 with the other hand. A handle can be located behind the stop 3 (not shown). The force generated by the impact is transferred from the impact rod 1 via the adapter 9, the hook 6 and the cable loop 4 to the drive shaft 20, which is gently released. The impact procedure is repeated if necessary until the drive shaft 20 is released.

### List of Reference Signs

1 Impact rod
2 Impact weight
3 Stop
4 Cable loop
5 Adjustment element
6 Hook/fastening element
7 Spring clip fastener
8 Eyelet
9 Adapter
10 Bent part
11 Larger bent surface
12 Smaller bent surface, opposite surface 11
13 Third bent surface
14 U-bolt
15 Long U-leg
16 Short U-leg
17 U-base
18 Thread
19 Locking screw
20 Drive shaft
21 Tool

1. A tool for releasing a stuck part, comprising:
an impact rod;
a movable impact weight guided on the impact rod;
a stop at one end of the impact rod;
a fastening element at the other end of the impact rod, the fastening element configured to receive a cable loop;
the cable loop configured to affix to the stuck part; and
an adjusting element configured for tool-free adjustment of a width of the cable loop.

2. The tool of claim 1, wherein the adjusting element comprises a bent part, a U-bolt having a long U-leg with a thread, a short U-leg, a U-base connecting the long U-leg and the short U-leg, and a locking screw threaded onto the thread of the long U-leg, wherein the long U-leg passes through two holes in opposite bent surfaces of the bent part, the U-base is arranged parallel to a larger one of the bent surfaces, and the short U-leg is inserted into a hole in the larger bent surface while spaced from the smaller bent surface.

3. The tool of claim 2, wherein the bent part includes a third bent surface aligned orthogonally to the two opposite bent surfaces on a side of the short U-leg.

4. The tool of claim 2, wherein the cable loop lies between the U-base and the larger bent surface of the bent part.

5. The tool of claim 1, wherein the fastening element comprises a hook with a spring clip fastener and is pivotally attached to a slotted adapter that connects the hook to the impact rod.

6. The tool of claim 1, wherein the cable loop is secured to the fastening element via two eyelets disposed at opposing ends of the cable loop.

7. The tool of claim 1, wherein the cable loop comprises a steel cable.
